(19) United States
(12) Patent Application Publication
(10) Pub. No.: US 2006/0265646 A1
(43) Pub. Date: Nov. 23, 2006

(54) System, method, and computer program product for detection of potentially-problematic terminology in documents

(75) Inventor: Laura Lee Girolami Rose, Raleigh, NC (US)

Correspondence Address: IBM CORPORATION (SYL-RSW);C/O SYNNESTVEDT & LECHNER LLP, 1101 MARKET STREET, SUITE 2600, PHILADELPHIA, PA, 19107, US

(73) Assignee: International Business Machines Corporation, Armonk, NY (US)

(21) Appl. No.: 11/135,120

(22) Filed: May 23, 2005

(51) Int. Cl. G06F 17/00

(52) U.S. Cl. 715/530; 707/3; 707/6

(57) ABSTRACT

A processing tool is disclosed that scans a document looking for predetermined potentially problematic terms (“flag terms”), provides a description of what may be wrong with use of the terms, provides an opportunity for correction, and has the ability to produce reports such as statistical reports on the number of flag terms, the number of flag terms corrected, the point in the development cycle that the corrections were made, and the potential cost savings resulting from identifying the flag terms and correcting them at an early stage in the process.

### BACKGROUND OF THE INVENTION

1. Field of the Invention

This invention relates to tools for improving the quality and precision of written documents and, more particularly, to a tool for analyzing written documents and, if desired, correcting problems found as a result of the analysis.

2. Description of the Related Art

Certain types of writing require great precision in the use of terminology. Technical specifications, requirements documents, requests for proposals, and even patent applications require great care in drafting so that the information being conveyed is clearly understood and so that the intention of the author is accurately stated.

The process involved in creating a software application, sometimes referred to as the software “life cycle”, typically involves multiple phases or stages, e.g., the requirement development stage, the development/code review stage, the test stage, the deployment stage, and the post-deployment/delivery stage. The exact stages of the developmental cycle are not as important as understanding that at each stage of the cycle, the application progresses closer to completion. Errors or defects occurring in the requirement development stage can negatively impact the entire application, and if the errors or defects remain in the application through the deployment stage, it can be extremely costly to the developer, as there may be a need to recall software and/or provide updates and modifications to software that is already being used at customer locations. Accordingly, it is highly desirable to identify such defects or errors as early in the process as possible.

In the realm of software development, the beginning stage typically is the requirements development stage, which involves the creation of a “requirements document”. The requirements document is a document that specifies the various tasks to be performed by the proposed software. Statistics show that the majority of software defects are caused by vague, imprecise, ambiguous and/or missing requirements in the requirements document. Books have been written on the subject of “how not to write” a requirements document, and such books include suggestions on specific words to avoid and problem words, and also suggest terms that typically make for a high quality requirement specification.

Putting into practice the recommendations in “how to” (or “how not to”) guides can be time consuming and difficult. Locating words that may be problematic in a requirements document takes time, and once they are found, a determination must be made as to whether or not they are indeed, in the context in which they are used, problem words. It is largely a manual process, which can be assisted through the use of word search capabilities of word processing systems. However, such systems rely on the knowledge of the operator to know which words to search for, to know the problems with these words, and to analyze them and make sure that they are indeed problematic uses. Further, it would be desirable to have a way of tracking the occurrence of corrected problem terms and be able to easily prepare reports and other analytical devices to allow judgements to be made, both as to the work of the person who authored the document and as to the amount of time and/or money saved by catching the defects at an early stage in the process. Having a tool that automatically identifies potentially problematic terms in a requirements document would reduce software development costs; however, prior to the present invention, no such tool existed.

### SUMMARY OF THE INVENTION

The present invention is a processing tool that scans a document looking for predetermined “flag terms”, provides a description of what may be wrong with using the flag terms, provides an opportunity for correction, and has the ability to produce reports such as statistical reports on the number of flag terms, the number of flag terms corrected, the point in the development cycle that the corrections were made, and the potential cost savings resulting from identifying the flag terms and correcting them at an early stage in the process.

### BRIEF DESCRIPTION OF THE DRAWINGS

FIG. 1 is a flowchart illustrating the basic steps performed by a processor in accordance with the present invention;

FIG. 2 is a flowchart illustrating an example of process steps to be performed to enable the reporting process;

FIG. 3 is a sample GUI window illustrating an example of how the present invention might appear on a typical computer screen when in use; and

FIG. 4 illustrates a representative workstation hardware environment in which the present invention may be practiced.

### DETAILED DESCRIPTION OF THE PREFERRED EMBODIMENTS

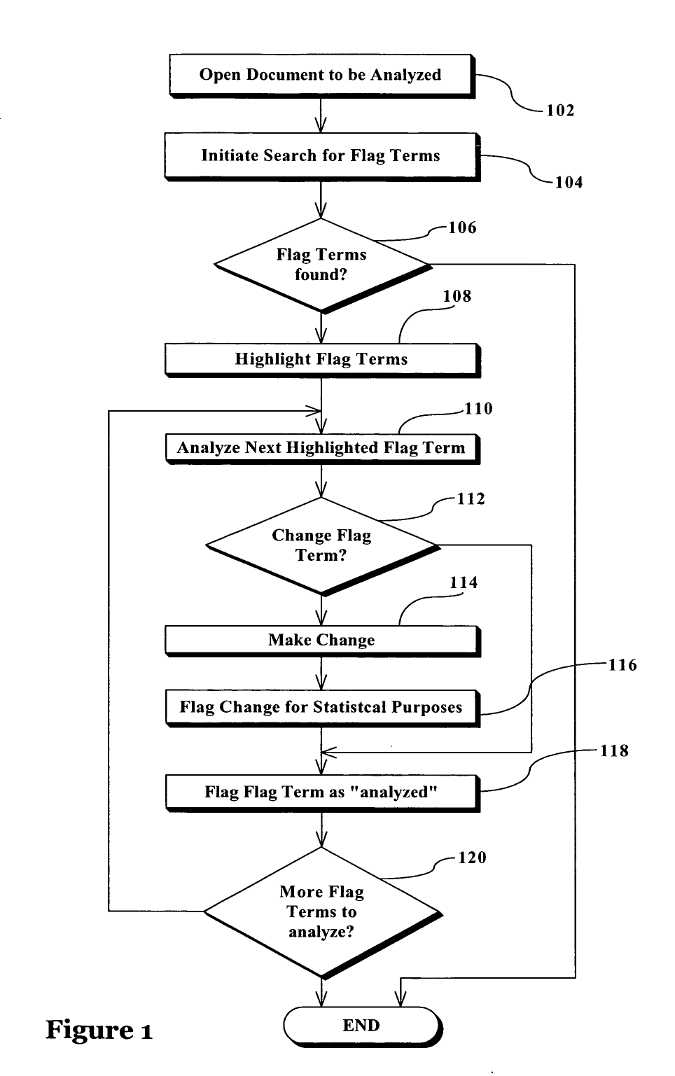

FIG. 1 is a flowchart illustrating the basic steps performed by a processor in accordance with the present invention. In the preferred embodiment, the processor is a computer system configured with software to perform the steps of FIG. 1. In a typical use, a requirements document, authored using word processing or other authoring software, resides in storage (temporary or fixed) on the computer system. A stand alone program, a plug-in, or any other known method of executing software that performs the steps of FIG. 1 may be utilized. The basic elements of the invention thus comprise a storage element in which a list of predetermined flag terms resides, a scanning tool (e.g., software code and/or a software module that configures the computer to go through the document looking for instances of the predetermined flag terms, and a display tool (e.g., software code and/or a software module that configures the computer to highlight the found instances of flag terms so that they are easily discernable in a printed or electronic display of the document).

At step 102, a document (or documents) to be analyzed is opened, and at step 104, a search is initiated looking for flag terms. As used herein, flag terms are words, phrases, or terms that have been found to be imprecise, vague, ambiguous, too limiting, not limiting enough, or that otherwise cause problems in interpreting their meaning in the context of the document they are in. In other words, flag terms are actual words, phrases, or terms that are correctly spelled and which may be grammatically correct, but which may lack the precision, clarity, accuracy, or definiteness necessary for a document to be considered a precise and clear document. Any known word searching/phrase searching technique may be used to perform the search function. As described in more detail below, a “library” of flag terms can be created and accessed to provide target flag terms for which to search.

At step 106, a determination is made as to whether or not any flag terms have been found. If no flag terms are found, the process proceeds to the end where the process terminates. However, if, at step 106, a flag term is found, then at step 108, the flag term is highlighted using any known method for calling attention to the word or phrase, e.g., by changing the background color around the words, underlining them, bolding the text, etc. In a preferred embodiment, this step is performed for all flag terms within the document before continuing. However it is understood that each flag term can be identified and then analyzed one at a time, if desired.

At step 110, the first flag term that has been highlighted is analyzed. This will typically involve a user of the system viewing the on-screen document and reading a displayed description of what is wrong with the words or sentence. For example, the user can hover a mouse pointer over the first highlighted flag term, and as a result, have a help box appear with a text message indicating the potential problem with the word or phrase. Other options are also available, for example, the text message could appear in a status line at the bottom of the screen. Any method of displaying text messages on the screen in such a way that it can be associated with the highlighted flag term can be used. The text message can be stored in the same library where the flag terms are stored, with each flag term having one or more appropriate text messages associated therewith.

Since the use of a hovering mouse pointer typically results in a “volatile” display that disappears when the mouse pointer is removed from the highlighted text, in any printed form (e.g., in one of the reports, discussed below) the descriptions of the problem could appear in a column next to the highlighted sentence, or on a separate page, in brackets, or using any other means that allows it to be permanently displayed, preferably without disrupting the flow of the sentence in which the flag term appears.

At step 112, after analyzing the highlighted flag term, a determination is made as to whether or not the flag term should be changed. If there is no need to change the flag term, that is, if the word(s) that were used are the words that the person actually wanted to use and they accurately convey the desired information with appropriate clarity, then the process proceeds directly to step 118, discussed in more detail below. If, however, at step 112, it is determined that the flag term is to be changed, then at step 114, the user is given the opportunity to make the change (by manual entry, by selection of a change option from a drop down list, etc.), and then at step 116, the change can be flagged for statistical purposes. In other words, the changed portion of text is designated as a changed item so that it can later be retrieved, counted, analyzed, etc. as such.

At step 118, the now analyzed and, if needed, changed flag terms can also be flagged as having been analyzed. This allows the user to bypass that instance of the word or phrase in a subsequent analysis of the same text; once the text has been analyzed and approved, or analyzed, changed and approved, it would be a waste of time to go back and check it again. Accordingly, by flagging it as “analyzed”, the system can be configured to skip the flagged text on the next analysis process.

At step 120, it is determined if there are any additional flag terms to be analyzed. If there are additional flag terms to be analyzed, the process proceeds back to step 110 and the process is repeated. If, at step 120, it is determined there are no more additional flag terms to analyze, then the process ends.

If desired, a default list of rules (problem words, flag terms, etc.) can be provided with the program. Additionally, they may be imported and/or added on the fly using known input techniques. Regardless of how the list of rules are provided, they are stored in a database or data file in such a manner that they can be accessed during the process described in FIG. 1. In the preferred embodiment, the problem words also include associated problem descriptions (e.g., text messages displayable on a display device and/or in a printed document) of the possible problems, and possibly also recommended alternative terms. Correction can be initiated by any known means, e.g., by provision of a text entry box accessed by right-clicking the help box displaying the text message or by clicking on a “correction” button. The exact method used is a matter of design choice.

Following is a list of exemplary flag terms and their associated problem descriptions. These are given for purpose of example only and the present invention is not limited to this list.
Always: If you see words such as these that denote something as certain and absolute, make sure that it is indeed, certain. Think of cases that violate them, when reviewing the spec.
Every: If you see words such as these that denote something as certain and absolute, make sure that it is indeed, certain. Think of cases that violate them, when reviewing the spec.
All: If you see words such as these that denote something as certain and absolute, make sure that it is indeed, certain. Think of cases that violate them, when reviewing the spec.
None: If you see words such as these that denote something as certain and absolute, make sure that it is indeed, certain. Think of cases that violate them, when reviewing the spec.
Never: If you see words such as these that denote something as certain and absolute, make sure that it is indeed, certain. Think of cases that violate them, when reviewing the spec.
Certainly: These words tend to persuade you into accepting something as a given. Don't fall into the trap
Therefore: These words tend to persuade you into accepting something as a given. Don't fall into the trap
Clearly: These words tend to persuade you into accepting something as a given. Don't fall into the trap
Obviously: These words tend to persuade you into accepting something as a given. Don't fall into the trap
Ordinarily: These words tend to persuade you into accepting something as a given. Don't fall into the trap
Customarily: These words tend to persuade you into accepting something as a given. Don't fall into the trap
Most: These words tend to persuade you into accepting something as a given. Don't fall into the trap
Mostly: These words tend to persuade you into accepting something as a given. Don't fall into the trap
etc.: Lists that finish with these words aren't testable. There needs to be no confusion as to how the series is generated and what appears next in the list.
And So Forth: Lists that finish with these words aren't testable. There needs to be no confusion as to how the series is generated and what appears next in the list.
And So On: Lists that finish with these words aren't testable. There needs to be no confusion as to how the series is generated and what appears next in the list.
Such As: Lists that finish with these words aren't testable. There needs to be no confusion as to how the series is generated and what appears next in the list.
Good: These are unquantifiable terms. They aren't testable. If they appear in a specification, they must be further defined to explain exactly what they mean.
Fast: These are unquantifiable terms. They aren't testable. If they appear in a specification, they must be further defined to explain exactly what they mean.
Cheap: These are unquantifiable terms. They aren't testable. If they appear in a specification, they must be further defined to explain exactly what they mean.
Efficient: These are unquantifiable terms. They aren't testable. If they appear in a specification, they must be further defined to explain exactly what they mean.
Small: These are unquantifiable terms. They aren't testable. If they appear in a specification, they must be further defined to explain exactly what they mean.
Stable: These are unquantifiable terms. They aren't testable. If they appear in a specification, they must be further defined to explain exactly what they mean.
Handled: These terms can hide large amounts of functionality and need to be specified.
Processed: These terms can hide large amounts of functionality and need to be specified.
Rejected: These terms can hide large amounts of functionality and need to be specified.
Skipped: These terms can hide large amounts of functionality and need to be specified.
Eliminated: These terms can hide large amounts of functionality and need to be specified.
If: Look for statements that have “If. . . Then” clauses but don't have a matching “else”. Ask yourself what will happen if the “if” doesn't happen.

As noted above, in addition to identifying the flag terms, the present invention also provides reporting capability. For example, a simple summary report of just the “suspect sentences” (those containing flag terms) and the associated problem descriptions can be provided. Another report could list a total count of “suspect defect areas,” i.e., the number of flag terms found in the initial analysis process. Still another report could identify the cost savings resulting from finding the problem and correcting it during the requirements stage as compared to finding and correcting the same problem at a later stage in the development cycle. These types of reports are listed for the purpose of example, and it is understood that numerous other reports will be apparent to a system designer and can be created, and the creation of such reports falls within the scope of the present invention.

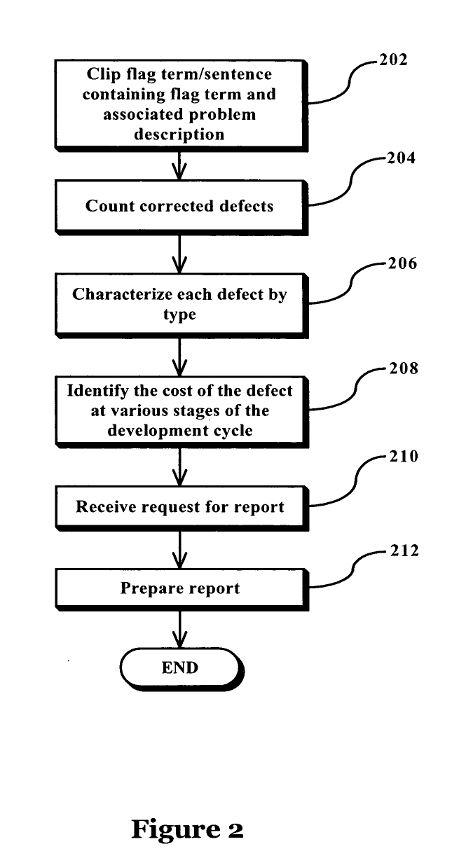

FIG. 2 is a flowchart illustrating an example of process steps to be performed to enable the reporting process. At step 202, a flag term and/or sentence containing a flag term is copied, along with the associated problem description. These areas are identified and displayed via the process of FIG. 1. The copying process is functionally equivalent to the “copy” function in a standard “copy and paste” process, that is, the text is selected and stored in a cache or other memory area. However, in the present invention, this process is performed automatically, rather than by mouse manipulations by the user.

At step 204, the corrected defects (which were flagged at step 116 of FIG. 1) are counted and totaled. If desired, at step 206, each defect found can be characterized as being of a certain type, e.g., ambiguous, not testable, etc.

At step 208, the cost of each defect at various stages of the development cycle is identified. This can be accomplished, by, for example, referencing the studies described above and correlating each type of defect with a cost as defined in the studies.

At step 210, a request is received for a report. The request can be input using any known means, for example, by inputting the request on a computer keyboard and/or selecting a particular report from a drop-down menu on a computer screen. Depending on the type of report requested, the appropriate information obtained in steps 202-208 is utilized. For example, if the user requested a count of corrected defects, the information gleaned from step 204 would be utilized. If, instead, the user wanted a count of corrected defects categorized by defect type, then the information gleaned from steps 204 and 206 would be utilized. The reporting process of the present invention is not limited to the reporting functions described herein, as numerous alternative reports will be apparent to an artisan of ordinary skill.

At step 212, a report is prepared based upon the request made in step 210. The report is delivered to the user, e.g., by delivery to a computer screen, to a printer, etc. The process then ends.

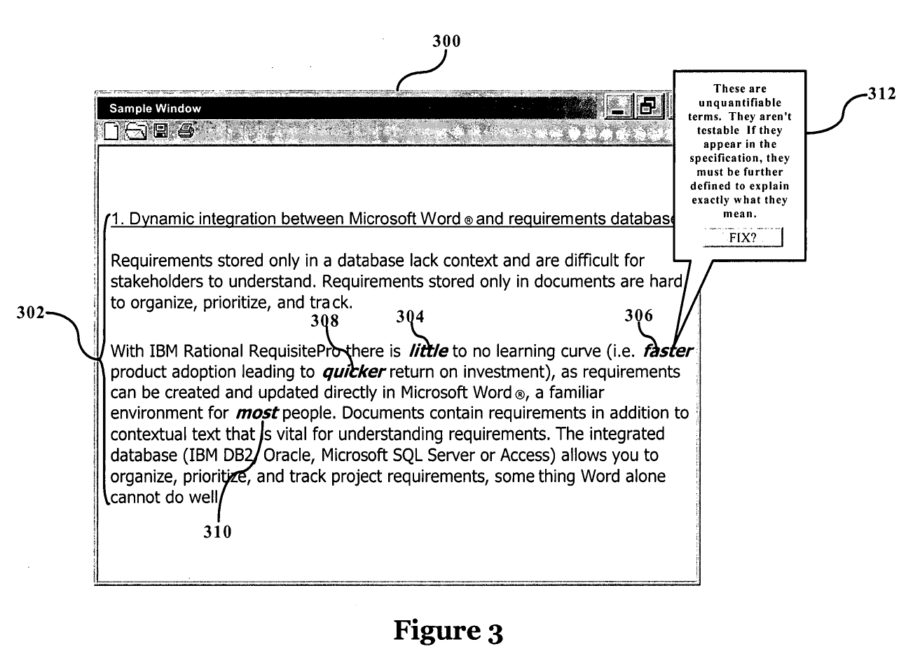

FIG. 3 is a sample GUI window illustrating an example of how the present invention might appear on a typical computer screen when in use. Referring to FIG. 3, a GUI window 300 contains text 302 which has been analyzed using the present invention. As can be seen, words 304, 306, 308, and 310 have been italicized and bolded to highlight them on the screen. Word 306, “faster” is shown as it would look if a mouse pointer (not shown) were hovered over the word. As can be seen, a help box 312 displays the text “These are unquantifiable terms. They aren't testable. If they appear in the specification, they must be further defined to explain exactly what they mean.” Each highlighted term in the text will have an associated text message displayed when the term is designated by the mouse pointer.

Also shown within the text box 312 is a “FIX?” button 314. By clicking on the button 312, a dropdown menu or other means of displaying selectable or non-selectable suggested corrections can be displayed for the user. If there are selectable options, the user may click on one of the options and the term will be replaced with the suggested text. Obviously, the exact method of enabling correction and displaying the text boxes is a matter of design choice, and numerous other ways of displaying this functionality will be readily apparent to the designer.

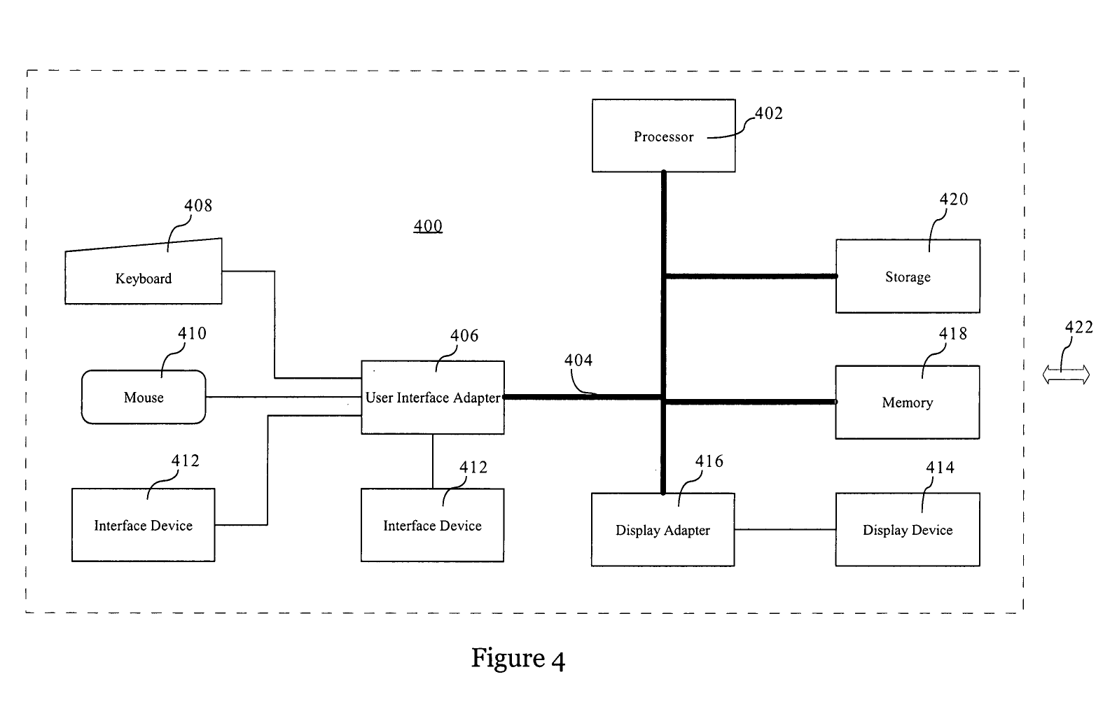

FIG. 4 illustrates a representative workstation hardware environment in which the present invention may be practiced. The environment of FIG. 4 comprises a representative single user computer workstation 400, such as a personal computer, including related peripheral devices. The workstation 400 includes a microprocessor 402 and a bus 404 employed to connect and enable communication between the microprocessor 402 and the components of the workstation 400 in accordance with known techniques. The workstation 400 typically includes a user interface adapter 406, which connects the microprocessor 402 via the bus 404 to one or more interface devices, such as keyboard 408, mouse 410, and/or other interface devices 412, which can be any user interface device, such as a touch sensitive screen, digitized entry pad, etc. The bus 404 also connects a display device 414, such as an LCD screen or monitor, to the microprocessor 402 via a display adapter 416. The bus 404 also connects the microprocessor 402 to memory 418 and long term storage 420 which can include a hard drive, tape drive, etc.

The workstation 400 communicates via a communications channel 422 with other computers or networks of computers. The workstation 400 may be associated with such other computers in a local area network (LAN) or a wide area network, or the workstation 400 can be client in a client/server arrangement with another computer, etc. All of these configurations, as well as the appropriate communications hardware and software, are known in the art.

The examples described above are given in the context of the use of the present invention in connection with requirements documents typically used at the beginning of the development of software; however, it is understood that the present invention is not so limited, and that it will have utility in any situation where there is a need to analyze documents to determine if they contain certain target words, phrases, sentences, images and the like that are potentially problematic. Further, although the present invention is contemplated for use in the identification of potentially problematic terminology, it can also be sued in any situation where there is a need or desire to locate target terms of any kind.

The above-described steps can be implemented using standard well-known programming techniques. The novelty of the above-described embodiment lies not in the specific programming techniques but in the use of the steps described to achieve the described results. Software programming code which embodies the present invention is typically stored in permanent storage of a computer being used to perform the functions of the present invention. In a client/server environment, such software programming code may be stored with storage associated with a server. The software programming code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, the figures support combinations of means for performing the specified functions, combinations of steps for performing the specified functions, and program instruction means for performing the specified functions.

Although the present invention has been described with respect to a specific preferred embodiment thereof, various changes and modifications may be suggested to one skilled in the art and it is intended that the present invention encompass such changes and modifications as fall within the scope of the appended claims.

We claim:

1. A computer-implemented analysis tool for analyzing a written document to identify potentially problematic flag terms, comprising:
a storage element storing a list of one or more predetermined flag terms;
a scanning tool, coupled to said storage element, that scans the written document and locates any instances of the flag terms in said stored list that occur in the written document; and
a display tool, coupled to said scanning tool, displaying, in a highlighted format, any instances of the flag terms located by said scanning tool.

2. The tool of claim 1, wherein said flag terms comprise terms that are vague.

3. The tool of claim 1, wherein said flag terms comprise terms that are ambiguous.

4. The tool of claim 1, wherein said flag terms comprise terms that are absolute terms.

5. The tool of claim 1, wherein said flag terms comprise terms that are at least one of absolute, vague, or ambiguous terms

6. The tool of claim 5, wherein said display tool also displays, for each instance of the displayed flag terms, a description of a problem associated with use of its associated flag term.

7. The tool of claim 6, further comprising:
a reporting tool enabling the compilation and display of one or more reports based on the instances of flag terms located by said scanning tool.

8. A computer-implemented method for analyzing a written document to identify potentially problematic flag terms, comprising:
storing in memory of a computer a list of one or more predetermined flag terms;
electronically scanning the written document using said computer and locating any instances of the flag terms in said stored list that occur in the written document; and
displaying, in a highlighted format, any instances of the flag terms located by said scanning.

9. The method of claim 8, wherein said flag terms comprise terms that are vague.

10. The method of claim 8, wherein said flag terms comprise terms that are ambiguous.

11. The method of claim 8, wherein said flag terms comprise terms that are absolute terms.

12. The method of claim 8, wherein said flag terms comprise terms that are at least one of absolute, vague, or ambiguous terms

13. The method of claim 12, wherein said display step further comprises:
displaying, for each instance of the displayed flag terms, a description of a problem associated with use of its associated flag term.

14. The method of claim 13, further comprising:
compiling and displaying one or more reports based on the instances of flag terms located by said scanning.

15. A computer program product for analyzing a written document to identify potentially problematic flag terms, comprising:
computer-readable means for storing in memory of a computer a list of one or more predetermined flag terms;
computer-readable means for electronically scanning the written document using said computer and locating any instances of the flag terms in said stored list that occur in the written document; and
computer-readable means for displaying, in a highlighted format, any instances of the flag terms located by said scanning.

16. The computer program product of claim 15, wherein said flag terms comprise terms that are vague.

17. The computer program product of claim 15, wherein said flag terms comprise terms that are ambiguous.

18. The computer program product of claim 15, wherein said flag terms comprise terms that are absolute terms.

19. The computer program product of claim 15, wherein said flag terms comprise terms that are at least one of absolute, vague, or ambiguous terms

20. The computer program product of claim 19, wherein said computer-readable means for displaying further comprises:
computer-readable means for displaying, for each instance of the displayed flag terms, a description of a problem associated with use of its associated flag term.

21. The computer program product of claim 20, further comprising:
computer-readable means for compiling and displaying one or more reports based on the instances of flag terms located by said scanning.
